(19) United States
(12) Patent Application Publication
(10) Pub. No.: US 2015/0149146 A1
(43) Pub. Date: May 28, 2015

(54) SYSTEMS FOR DELIVERY OF AUDIO SIGNALS TO MOBILE DEVICES

(71) Applicants: Jay Abramovitz, Portland, OR (US); Mark Moors, Vancouver, WA (US)

(72) Inventors: Jay Abramovitz, Portland, OR (US); Mark Moors, Vancouver, WA (US)

(21) Appl. No.: 14/088,318

(22) Filed: Nov. 22, 2013

(51) Int. Cl. G06F 17/28; H04R 3/12

(52) U.S. Cl. CPC G06F 17/289; H04R 3/12
USPC 704/2; 381/80

(57) ABSTRACT

The present disclosure is directed to an audio delivery system including an audio source, an audio conversion device, a wireless transmitter, and mobile devices. The audio source is configured to deliver raw audio output in a first format to the audio conversion device. The audio conversion device is configured to receive the raw audio output, parse the raw audio output into data packets, transmit the data packets to a network location for conversion into a second format, receive the converted data packets from the network location, and transmit the converted data packets over a wireless network. The wireless transmitter is configured to generate a wireless network in a localized area for transmission of the converted data packets to the mobile devices. The mobile devices are configured to receive instructions from a user, receive the converted data packets, and present the converted data packets to the user in the second format based on the user instructions. In one example, the second format includes an audible foreign language translation and/or a readable text foreign language translation. In another example, the second format includes a readable text original language translation. In even another example, the second format includes an enhanced audio frequency range.

### BACKGROUND

The present disclosure relates generally to systems for delivery of audio output to mobile devices. In particular, systems for delivery of audio output to mobile devices in an environment where a language translation is desirable, in a high ambient noise environment, and/or in any environment where it is desirable for a user to receive audio output in one or more of an audible format and a readable format on a personal mobile device are described.

In some environments, it is desirable for an individual user (e.g., attendee, participant, patron, etc.) to receive an individual audio signal in either of an audible and/or a visual (i.e., readable) format. For example, in a typical conference environment or theater environment, a presentation, play, or film is offered only in one language. If attendees are not fluent in the provided language, they may not be able to understand concepts and/or storylines.

In some cases, foreign attendees may have a personal translator or a public translator may be present to give a direct spoken translation, but this has the disadvantage that the spoken translation may disrupt the surrounding attendees and/or the flow of the presentation, play, or film. Further, even if a translator is provided as part of the presentation, play, or film, there may be multiple dialects of foreign language-speaking attendees. Therefore a single translator may be ineffective for providing translation services to all attendees.

In another example, in sports bars, gyms, waiting rooms, and other busy environments there is often a high degree of ambient noise that may make it difficult for a patron to hear audio output from a television, especially if the patron has a hearing impairment. There may be multiple televisions present in the environment each projecting its own audio output, which may further contribute to the ambient noise and/or the inability of a patron to hear the desired audio output.

It is possible to provide closed-captioning on a television screen in order to convey a text format of the spoken language in the audio content. Closed-captioning, however, has the disadvantages that patrons are required to pay close attention to the television throughout the program, patrons are required to sit in a location where the closed-captioning is readable on the television screen, other audio content (e.g. noise from a crowd, music, sound effects, etc.) is lost, and it detracts from the visual experience of the program. Further, as in the example above, a foreign language translation may be desirable if the patron is not fluent in the language of the presented television program.

Additionally, in either of the above examples, an attendee or patron may have partial or complete hearing impairment. In the case of complete hearing impairment, the attendee or patron may not be able to hear the presentation, performance, film, and/or television program. Closed-captioning may be provided on a screen at the front of the presentation and/or on a television screen. This, however, has the disadvantages described above that a person must be positioned at a location where the text is viewable and it detracts from the visual experience. Alternatively, a patron may have only partial hearing impairment and may not necessarily require closed-captioning, but must have amplified audio of specific frequencies in order to sufficiently hear the audio output.

Thus, there exists a need for a system that can deliver an audio output to an individual user in an audible format and/or a readable format. Examples of new and useful systems for delivery of audio signals to mobile devices relevant to the needs existing in the field are discussed below.

Disclosure addressing one or more of the identified existing needs is provided in the detailed description below. Examples of references relevant to audio output delivery systems include U.S. Patent References: patent application publication 20120087507, patent application publication 20120308032, patent application publication 20120308033, patent application publication 20120308035, patent application publication 20120309366, patent application publication 20120311642. The complete disclosures of the above patents and patent applications are herein incorporated by reference for all purposes.

### SUMMARY

The present disclosure is directed to an audio delivery system including an audio source, an audio conversion device, a wireless transmitter, and mobile devices. The audio source is configured to deliver raw audio output in a first format to the audio conversion device. The audio conversion device is configured to receive the raw audio output, parse the raw audio output into data packets, transmit the data packets to a network location for conversion into a second format, receive the converted data packets from the network location, and transmit the converted data packets over a wireless network. The wireless transmitter is configured to generate a wireless network in a localized area for transmission of the converted data packets to the mobile devices. The mobile devices are configured to receive instructions from a user, receive the converted data packets, and present the converted data packets to the user in the second format based on the user instructions. In one example, the second format includes an audible foreign language translation and/or a readable text foreign language translation. In another example, the second format includes a readable text original language translation. In even another example, the second format includes an enhanced audio frequency range.

### BRIEF DESCRIPTION OF THE DRAWINGS

FIG. 1 shows a schematic view of an example of a programmable computing device.

FIG. 2 shows a schematic view of an example of a mobile electronic device.

FIG. 3 is a schematic view of a first example of a system for delivery of audio output to mobile devices including a network location and an audio conversion device, which may include a human translator.

FIG. 4 is a schematic view of a second example of a system for delivery of audio output to mobile devices including a network location and an audio conversion device.

FIG. 5 is a schematic view of the second example system for delivery of audio output to mobile devices show in FIG. 4 used in combination with another system for delivery of audio output to mobile devices.

FIG. 6 is a schematic view of a third example system for delivery of audio output to mobile devices where audio data format conversion and language conversion occurs within the audio data conversion device, which may be used in combination with a human translator.

FIG. 7 is a schematic view of a graphical user interface of an application for an example mobile device of any of the example systems for delivery of audio output to mobile devices shown in FIGS. 4-6.

### DETAILED DESCRIPTION

The disclosed systems for delivery of audio signals to mobile devices will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, a variety of systems for delivery of audio signals to mobile devices examples are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

Various disclosed examples may be implemented using electronic circuitry configured to perform one or more functions. For example, with some embodiments of the invention, the disclosed examples may be implemented using one or more application-specific integrated circuits (ASICs). More typically, however, components of various examples of the invention will be implemented using a programmable computing device executing firmware or software instructions, or by some combination of purpose-specific electronic circuitry and firmware or software instructions executing on a programmable computing device.

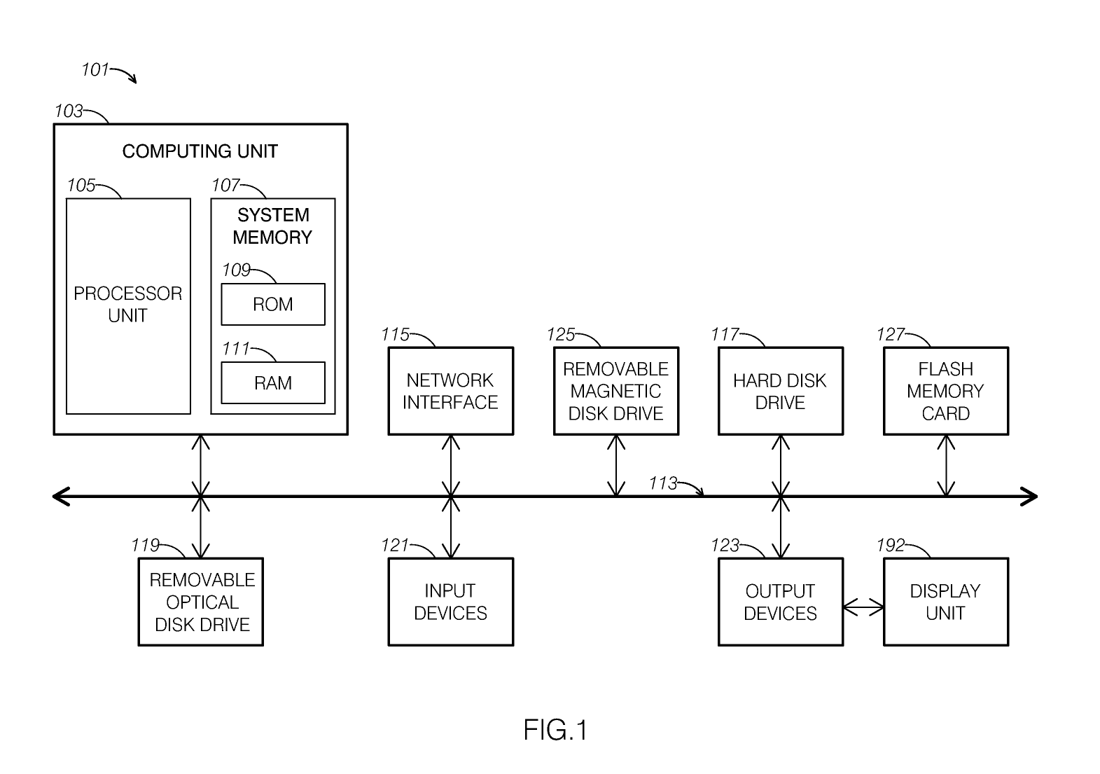

Accordingly, FIG. 1 shows one illustrative example of a computer, computer 101, which can be used to implement various embodiments of the invention. Computer 101 may be incorporated within a variety of consumer electronic devices, such as personal media players, cellular phones, smart phones, personal data assistants, global positioning system devices, and the like.

As seen in this figure, computer 101 has a computing unit 103. Computing unit 103 typically includes a processing unit 105 and a system memory 107. Processing unit 105 may be any type of processing device for executing software instructions, but will conventionally be a microprocessor device. System memory 107 may include both a read-only memory (ROM) 109 and a random access memory (RAM) 111. As will be appreciated by those of ordinary skill in the art, both read-only memory (ROM) 109 and random access memory (RAM) 111 may store software instructions to be executed by processing unit 105.

Processing unit 105 and system memory 107 are connected, either directly or indirectly, through a bus 113 or alternate communication structure to one or more peripheral devices. For example, processing unit 105 or system memory 107 may be directly or indirectly connected to additional memory storage, such as a hard disk drive 117, a removable optical disk drive 119, a removable magnetic disk drive 125, and a flash memory card 127. Processing unit 105 and system memory 107 also may be directly or indirectly connected to one or more input devices 121 and one or more output devices 123. Input devices 121 may include, for example, a keyboard, touch screen, a remote control pad, a pointing device (such as a mouse, touchpad, stylus, trackball, or joystick), a scanner, a camera or a microphone. Output devices 123 may include, for example, a monitor display, an integrated display, television, printer, stereo, or speakers.

Still further, computing unit 103 will be directly or indirectly connected to one or more network interfaces 115 for communicating with a network. This type of network interface 115 is also sometimes referred to as a network adapter or network interface card (NIC). Network interface 115 translates data and control signals from computing unit 103 into network messages according to one or more communication protocols, such as the Transmission Control Protocol (TCP), the Internet Protocol (IP), and the User Datagram Protocol (UDP). These protocols are well known in the art, and thus will not be discussed here in more detail. An interface 115 may employ any suitable connection agent for connecting to a network, including, for example, a wireless transceiver, a power line adapter, a modem, or an Ethernet connection.

It should be appreciated that, in addition to the input, output and storage peripheral devices specifically listed above, the computing device may be connected to a variety of other peripheral devices, including some that may perform input, output and storage functions, or some combination thereof. For example, the computer 101 may be connected to a digital music player, such as an IPOD® brand digital music player or iOS or Android based smartphone. As known in the art, this type of digital music player can serve as both an output device for a computer (e.g., outputting music from a sound file or pictures from an image file) and a storage device.

In addition to a digital music player, computer 101 may be connected to or otherwise include one or more other peripheral devices, such as a telephone. The telephone may be, for example, a wireless “smart phone,” such as those featuring the Android or iOS operating systems. As known in the art, this type of telephone communicates through a wireless network using radio frequency transmissions. In addition to simple communication functionality, a “smart phone” may also provide a user with one or more data management functions, such as sending, receiving and viewing electronic messages (e.g., electronic mail messages, SMS text messages, images, etc.), recording or playing back sound files, recording or playing back image files (e.g., still picture or moving video image files), viewing and editing files with text (e.g., Microsoft Word or Excel files, or Adobe Acrobat files), etc. Because of the data management capability of this type of telephone, a user may connect the telephone with computer 101 so that their maintained data may be synchronized.

Of course, still other peripheral devices may be included with or otherwise connected to a computer 101 of the type illustrated in FIG. 1, as is well known in the art. In some cases, a peripheral device may be permanently or semi-permanently connected to computing unit 103. For example, with many computers, computing unit 103, hard disk drive 117, removable optical disk drive 119 and a display are semi-permanently encased in a single housing.

Still other peripheral devices may be removably connected to computer 101, however. Computer 101 may include, for example, one or more communication ports through which a peripheral device can be connected to computing unit 103 (either directly or indirectly through bus 113). These communication ports may thus include a parallel bus port or a serial bus port, such as a serial bus port using the Universal Serial Bus (USB) standard or the IEEE 1394 High Speed Serial Bus standard (e.g., a Firewire port). Alternately or additionally, computer 101 may include a wireless data “port,” such as a Bluetooth® interface, a Wi-Fi interface, an audio port, an infrared data port, or the like.

It should be appreciated that a computing device employed according to the various examples of the invention may include more components than computer 101 illustrated in FIG. 1, fewer components than computer 101, or a different combination of components than computer 101. Some implementations of the invention, for example, may employ one or more computing devices that are intended to have a very specific functionality, such as a digital music player or server computer. These computing devices may thus omit unnecessary peripherals, such as the network interface 115, removable optical disk drive 119, printers, scanners, external hard drives, etc. Some implementations of the invention may alternately or additionally employ computing devices that are intended to be capable of a wide variety of functions, such as a desktop or laptop personal computer. These computing devices may have any combination of peripheral devices or additional components as desired.

In many examples, computers may define mobile electronic devices, such as smartphones, tablet computers, or portable music players, often operating the iOS, Symbian, Linux, Windows-based (including Windows Mobile and Windows 8), or Android operating systems.

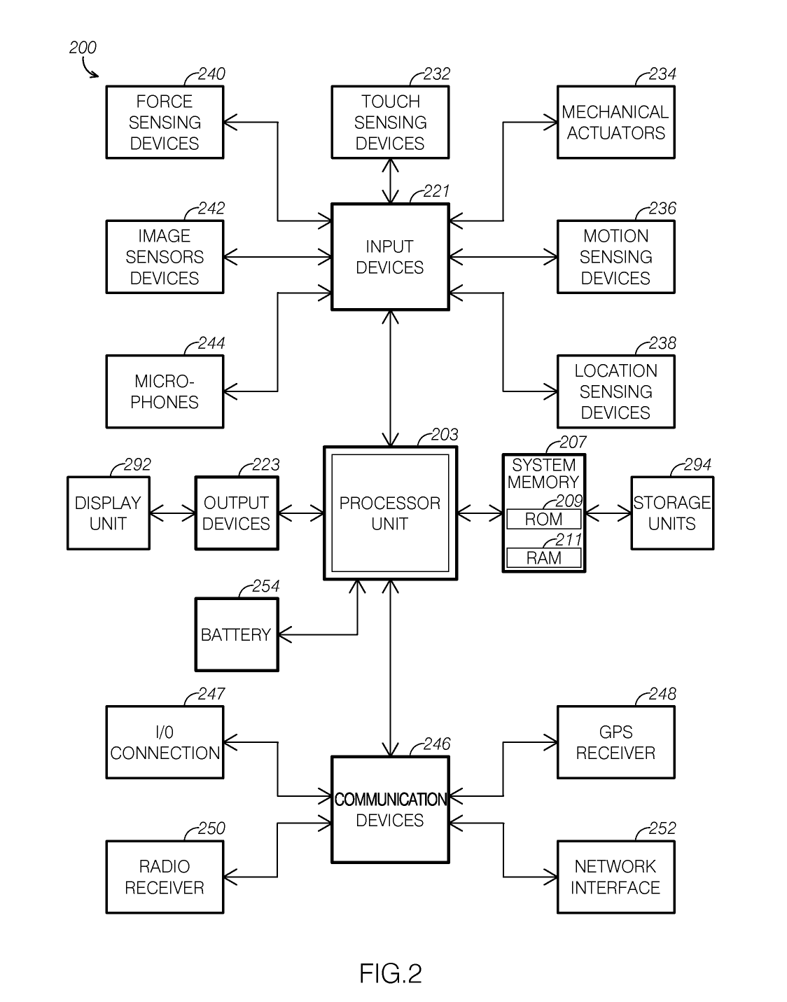

With reference to FIG. 2, an exemplary mobile device, mobile device 200, may include a processor unit 203 (e.g., CPU) configured to execute instructions and to carry out operations associated with the mobile device. For example, using instructions retrieved from memory, the controller may control the reception and manipulation of input and output data between components of the mobile device. The controller can be implemented on a single chip, multiple chips or multiple electrical components. For example, various architectures can be used for the controller, including dedicated or embedded processor, single purpose processor, controller, ASIC, etc. By way of example, the controller may include microprocessors, DSP, A/D converters, D/A converters, compression, decompression, etc.

In most cases, the controller together with an operating system operates to execute computer code and produce and use data. The operating system may correspond to well known operating systems such as iOS, Symbian, Linux, Windows-based (including Windows Mobile and Windows 8), or Android operating systems, or alternatively to special purpose operating systems, such as those used for limited purpose appliance-type devices. The operating system, other computer code and data may reside within a system memory 207 that is operatively coupled to the controller. System memory 207 generally provides a place to store computer code and data that are used by the mobile device. By way of example, system memory 207 may include read-only memory (ROM) 209, random-access memory (RAM) 211, etc. Further, system memory 207 may retrieve data from storage units 294, which may include a hard disk drive, flash memory, etc. In conjunction with system memory 207, storage units 294 may include a removable storage device such as an optical disc player that receives and plays DVDs, or card slots for receiving mediums such as memory cards (or memory sticks).

Mobile device 200 also includes input devices 221 that are operatively coupled to processor unit 203. Input devices 221 are configured to transfer data from the outside world into mobile device 200. As shown, input devices 221 may correspond to both data entry mechanisms and data capture mechanisms. In particular, input devices 221 may include the following: touch sensing devices 232 such as touch screens, touch pads and touch sensing surfaces; mechanical actuators 234 such as button or wheels or hold switches; motion sensing devices 236 such as accelerometers; location detecting devices 238 such as global positioning satellite receivers, WiFi based location detection functionality, or cellular radio based location detection functionality; force sensing devices such as force sensitive displays and housings; image sensors; and microphones. Input devices 221 may also include a clickable display actuator.

Mobile device 200 also includes various output devices 223 that are operatively coupled to processor unit 203. Output devices 223 are configured to transfer data from mobile device 200 to the outside world. Output devices 223 may include a display unit 292 such as an LCD, speakers or jacks, audio/tactile feedback devices, light indicators, and the like.

Mobile device 200 also includes various communication devices 246 that are operatively coupled to the controller. Communication devices 246 may, for example, include both an I/O connection 247 that may be wired or wirelessly connected to selected devices such as through IR, USB, or Firewire protocols, a global positioning satellite receiver 248, and a radio receiver 250 which may be configured to communicate over wireless phone and data connections. Communication devices 246 may also include a network interface 252 configured to communicate with a computer network through various means which may include wireless connectivity to a local wireless network, a wireless data connection to a cellular data network, a wired connection to a local or wide area computer network, or other suitable means for transmitting data over a computer network.

Mobile device 200 also includes a battery 254 and possibly a charging system. Battery 254 may be charged through a transformer and power cord or through a host device or through a docking station. In the cases of the docking station, the charging may be transmitted through electrical ports or possibly through an inductance charging means that does not require a physical electrical connection to be made.

The various aspects, features, embodiments or implementations of the invention described above can be used alone or in various combinations. The methods of this invention can be implemented by software, hardware or a combination of hardware and software. The invention can also be embodied as computer readable code on a computer readable medium. The computer readable medium is any data storage device that can store data which can thereafter be read by a computer system, including both transfer and non-transfer devices as defined above. Examples of the computer readable medium include read-only memory, random access memory, CD-ROMs, flash memory cards, DVDs, magnetic tape, optical data storage devices, and carrier waves. The computer readable medium can also be distributed over network-coupled computer systems so that the computer readable code is stored and executed in a distributed fashion.

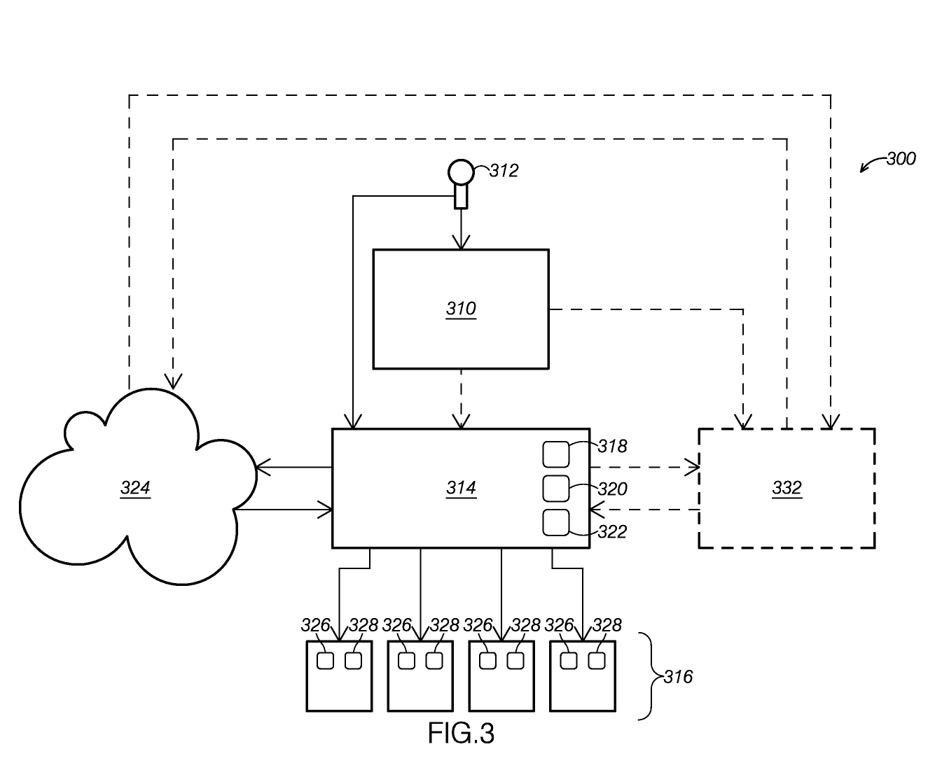

With reference to FIG. 3, a first example of a system for delivery of audio signals to mobile devices, audio delivery system 300, will now be described. Audio delivery system 300 is configured to receive raw audio output in a first format (e.g., a first language format and/or a normal frequency audio format), parse the raw audio output into data packets, and transmit the data packets over a wired and/or wireless network. Further, the data packets are converted into converted data packets including a second format (e.g., a second language format and/or an enhanced frequency audio format). In other words, the first format of the raw audio output is translated into a second format that can be transmitted over a wireless network. In one example, the converted data packets include an audible foreign language translation of the raw audio output (i.e., a second language format). In a second example, the converted data packets include text corresponding to the raw audio output that includes a foreign language translation of the raw audio output (i.e., a second language format). In a third example, the converted data packets include text corresponding to the raw audio output that is in the original language of the raw audio output (i.e., a second language format). In a fourth example, the converted data packets include an enhanced audio of a specific selected frequency range (i.e., an enhanced frequency audio format).

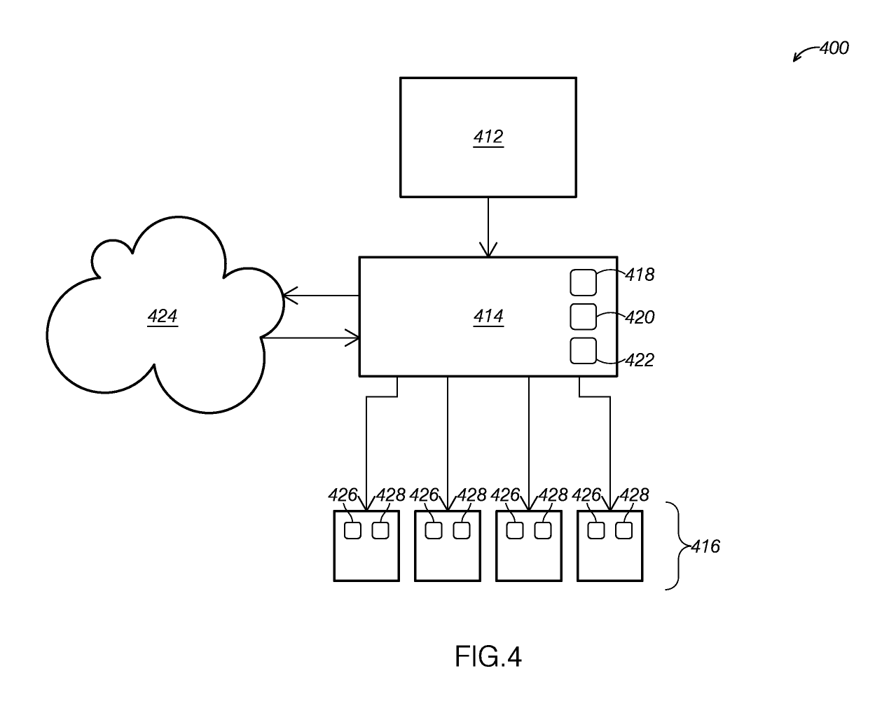

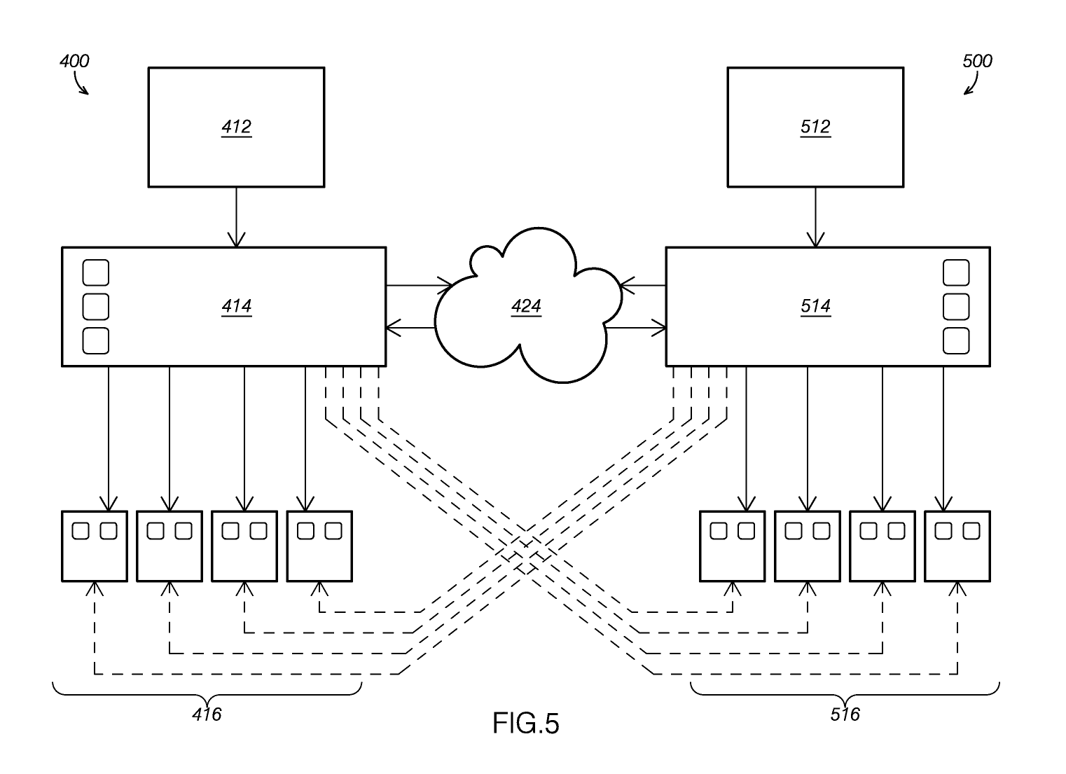

In an alternate embodiment, an audio delivery system 400 can be used in combination with a television audio source (as shown in FIG. 4). Additionally, audio delivery system 400 can be used in combination with one or more other audio delivery systems, such as audio delivery system 500 (as shown in FIG. 5). In another alternate embodiment, an audio delivery system 600 may exclude use of a network location for converting data packets from the first format into the second format.

Audio delivery system 300 addresses many of the shortcomings existing with conventional methods for conveying a foreign language translation of audio output in a conference environment where audible foreign language translations and/or readable text foreign language translations are desired. For example, a microphone of a public address system can be configured to provide a raw audio output to an audio delivery system. The raw audio output can be sent to a translator (e.g., human translator or an automatic translation program) and the translated audio output can then be delivered to one or more individual mobile devices.

Conference attendees may then hear the presentation delivered in a desired language without disruption to the presentation and/or surrounding attendees. Alternatively or additionally, the raw audio output can be converted to a text format of the foreign language and the conference attendees can read the text format of the delivered presentation (i.e., closed-captioning) on a screen of their respective mobile devices. It will be appreciated that this system can be used for theater and/or film audio translation and closed-captioning.

Audio delivery system 300 also addresses many of the shortcomings existing with conventional methods for conveying audio output to hearing impaired attendees in a conference environment. For example, a microphone of a public address system can be configured to provide a raw audio output to an audio delivery system. The raw audio output can be converted to separated out into various frequency ranges and one or more of the specific enhanced frequency ranges can be delivered to one or more mobile devices depending on a selection by a user of the mobile device.

Conference attendees may then hear the presentation delivered in a desired enhanced frequency range without disruption to the presentation and/or surrounding attendees. Alternatively or additionally, the raw audio output can be converted to a text format in the original language and the conference attendees can read the text format of the delivered presentation (i.e., closed-captioning) on a screen of their respective mobile devices. It will be appreciated that this system can be used for theater and/or film audio enhancement and/or closed-captioning.

As shown in FIG. 4, a second example audio delivery system, audio delivery system 400, addresses many of the shortcomings existing with conventional methods for conveying audio output in a high ambient noise environment. For example, as audio output is delivered to each user through a mobile device, each user receives an individualized high quality audio signal that can be personally adjusted to a desired volume level. Further, each user can select enhancement of a specific audio frequency range to improve the ability of a user having a hearing impairment to hear the audio and/or a user can receive a readable text of the audio output. Furthermore, users can receive an audible foreign language translation and/or a readable text foreign language translation of the audio output. Further still, because audio output is delivered to individual users, the television audio may be muted and decrease overall ambient noise in the environment, making it easier for other patrons to carry on conversation, place orders, and/or perform any other desired activity.

Audio delivery system 400 can also be used in combination with one or more other audio delivery systems, such as audio delivery system 500 shown in FIG. 5. A user can selectively listen to a program from either of a first or second audio output source (e.g., a first television or a second television). Moreover, with the combined use of audio delivery systems 400 and 500, the user may selectively switch between two or more audio output sources. Although two audio sources are depicted in FIG. 4, it will be appreciated that the audio delivery system may include any number of audio sources.

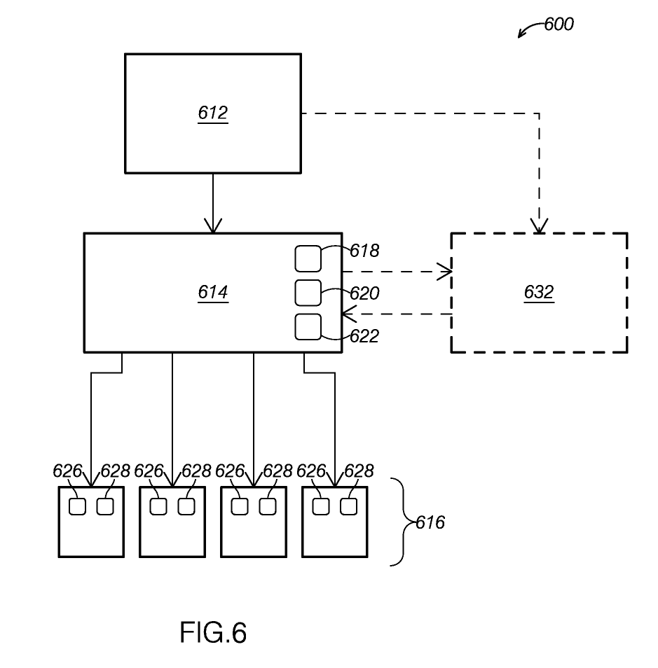

FIG. 6 includes a third example audio delivery system, audio delivery system 600. Audio delivery system 600 has the advantage that no external network location is required for converting the data packets into a second format. In other words, the third example audio conversion device is configured to receive raw audio output in a first format, parse the raw audio into data packets, convert the data packets into converted data packets including a second format, and transmit the converted data packets over a wireless network to one or more mobile devices.

As shown in FIG. 3, audio delivery system 300 includes a public address system 310 including a microphone 312, an audio conversion device 314, a network location 324, and a plurality of mobile devices 316. Audio delivery system 300 can optionally include a translator 332 (shown in dashed lines in FIG. 3). Audio output conversion device 314 includes a wireless transmitter 318, a computer 320, and a computer readable storage medium 322. In other examples, the audio delivery system may include a separate wireless transmitter that is not an internal component of the audio output conversion device. Computer 320 may include one or more of the components described above in reference to computer 101 (shown in FIG. 1).

Computer readable storage medium 322 includes computer readable instructions for receiving the raw audio output in a first format, parsing the raw audio output into a plurality of data packets, transmitting the plurality of data packets to the network location for converting to converted data packets in a second format, receiving the converted data packets from the network location, and transmitting the converted data packets to a plurality of mobile devices 316. Alternatively, raw audio output in the first format is sent to translator 332, computer readable storage medium 322 can further include computer readable instructions for sending and receiving audio data from the translator.

A flow of input and output audio data is depicted in FIG. 3. Raw audio output from microphone 312 is sent to public address system 310 and to audio output conversion device 314. Alternatively, the audio output from microphone 312 can be sent to public address system 310, and then from the public address system to audio conversion device 314. A volume of the public address system can be set to a desired volume.

The raw audio output is in a first format. Generally, raw audio output data from the public address system is in analog (e.g., Near Instantaneous Companded Audio Mulitiplex [NICAM], double-FM, Multichannel Television Sound [MTS], etc.) or digital formats (e.g., AC'97, Intel High Definition Audio, Alesis Digital Audio Tape [ADAT], AES3, AES47, Inter-IC Sound [I²S], Multichannel Audio Digital Interface [MADI], Musical Instrument Digital Interface [MIDI], Sony/Philips Digital Interface Format [S/PDIF], Tascam Digital Interconnect Format [TDIF], etc.). The raw audio data is normally not readable or transferable through a standard wireless internet connection (i.e., Wi-Fi), such as a wireless network of wireless transmitter 318.

From audio output conversion device 314, the raw audio output signal is parsed and sent to network location 330 (via an internet connection). Parsing of the raw audio output signal involves dividing the data into smaller portions or data packets and converting the data into a Wi-Fi transferable and computer readable format (e.g., Advanced Audio Distribution Profile [A2DP], mp3, Waveform Audio File Format [WAV], etc.). In one example, the data is temporally parsed and data packets correspond to 1/60 of a second of audio data. In another example, the data is parsed based on frequency of the audio and data packets correspond to a bass frequency (e.g., 32-512 Hz), a mid frequency (e.g., 512-2048 Hz), and a high frequency (e.g., 2048-8192 Hz). It will be appreciated that data packets may be parsed by any desired method.

Data packets can also be labeled with metadata tags. In one example, the data packets are given a header designating “Audio” for audio data and “Text” for text data. In this example, transmission of audio data is given preference over transmission of text data. In other words, transmission of audio data is given priority over transmission of text data so that the audio data transmission occurs substantially concurrently with the presentation, whereas text data may have a greater lag time. Data packets may be labeled with metadata tags at either of the audio conversion device or at the network location.

At network location 330, data packets are converted from the first format to the second format. In an example of audio frequency enhancement, one or more specific frequency ranges are enhanced (e.g., bass frequency, mid frequency, high frequency, etc.) from the raw audio output at the network location. The enhanced frequency range audio (selected enhanced frequency ranges) can then be combined with the normal frequency audio data (non-selected frequency ranges) and sent to audio conversion device 314 as converted audio packets.

In an example for language translation, automatic language translation is performed on the raw audio output at the network location. In a first specific example, language translation is an audible foreign language translation of the raw audio output. In a second specific example, language translation is text corresponding to the raw audio output that includes a foreign translation of the raw audio output. In a third specific example, language translation is text corresponding to the raw audio output that can include an original language translation of the raw audio output.

Additionally or alternatively, the raw audio output signal can be sent to a translator 332 (shown in dashed lines in FIG. 3). Translator 332 can be a human translator that is local or remote to the location of the presentation. In one example, the raw audio output can be sent to translator 332 via a hard wired internet connection, or parsed data can be sent from either of network 324 or audio conversion device 314 via a Wi-Fi connection. In another example, the translator is present in the conference room and directly hears the presented material. In even more examples, the audio is sent to the translator via a radio transmission, telephone transmission, or through a speaker system. Alternatively translator 332 may be a translating device that is in communication with either of the audio conversion device or the network location.

Translator 332 performs a language translation of the raw audio output from a first language format to a second language format. In one example, language translation is an audible foreign language translation of the raw audio output. In another example, language translation is a readable text foreign language translation. In even another example, language translation is a readable text original language translation. Translated audio output is then sent to audio conversion device 314 either directly or via network location 324.

For both of the above examples (audio frequency enhancement and/or language translation), converted data packets including the second format from either of network location 330 or translator 332 are then sent to audio conversion device 314. From audio conversion device 314, converted data packets are delivered to mobile devices 316 through a wireless network (e.g., IEEE 802.11, Simple Network Management Protocol [SNMP], etc.) provided in a localized area by wireless transmitter 318. It will be appreciated that data packets including the original language and normal frequency ranges may also be sent through the audio delivery system for delivery to mobile devices.

Each of the plurality of mobile devices 316 is capable of receiving a Wi-Fi signal. Each of the plurality of mobile devices 316 includes a computer 326 and a computer readable storage medium 328. Further, each of the plurality mobile devices 316 may include the features described above in reference to mobile device 200 (shown in FIG. 2).

Computer readable storage medium 328 includes computer readable instructions for receiving audio output from audio data conversion device 314. In one example, the computer readable instructions are an application for a mobile phone. In alternate embodiments, the computer readable instructions are an application for a tablet, a portable computer, an mp3 player, or any other mobile device capable of receiving a Wi-Fi signal.

Users may then listen to the audio corresponding to the given presentation via headphones associated with one of the mobile devices 316. Further, the users may adjust a volume of their mobile device to a desired volume. In alternate examples, the mobile devices may be heard through a speaker associated with the mobile device and/or the user may view closed-captioning on a screen of their mobile device.

Turning now to FIG. 4, an audio delivery system 400 is depicted. Audio delivery system 400 includes many similar or identical features to audio delivery system 300. Thus, for the sake of brevity, each feature of audio delivery system 400 will not be redundantly explained. Rather, key distinctions between audio delivery system 400 and audio delivery system 300 will be described in detail and the reader should reference the discussion above for features substantially similar between the two audio delivery systems.

Audio delivery system 400 includes a television 412, an audio output conversion device 414, and a plurality of mobile devices 416. Audio output conversion device 414 includes a wireless transmitter 418, a computer 420, and a computer readable storage medium 422. In other examples, the audio delivery system may include a separate wireless transmitter that is not an internal component of the audio output conversion device. Computer 420 may include the components described above in reference to computer 101 (shown in FIG. 1). It will be appreciated that the audio conversion device may be a component of the television. In other words, the television may be built to include the audio conversion device as an internal component.

Computer readable storage medium 422 includes computer readable instructions for receiving the raw audio output, parsing the raw audio output into a plurality of data packets, transmitting the plurality of data packets to the network location for converting from a first format to a second format (e.g., audio frequency enhancement, language translation, and/or a readable teaxt original language translation), receiving the audio output from the network location, and transmitting the audio output to the plurality of mobile devices.

A flow of audio input and output data is depicted in FIG. 4. A raw audio output signal from television 412 is sent to audio output conversion device 414. A volume of the television can be set to a desired volume or the television can be muted. Generally, raw audio output data from the television is in in analog or digital formats, such as those described above in reference to FIG. 3. The raw audio data is normally not readable or transferable through a standard wireless internet connection (i.e., Wi-Fi), such as wireless transmitter 418.

From audio output conversion device 414, the raw audio output signal is parsed into data packets and sent to a network location 424 (via an internet connection). At network location 424, the data packets are converted from the first format to the second format. The converted data packets may include an enhanced frequency audio, a foreign language translation, and/or a readable text original language translation. Additionally, metadata tags (such as those described above) can be added to the data packets. The converted data packets are then returned to audio output conversion device 314 via an internet connection.

The converted data packets are then sent to mobile devices 416 through a wireless network provided in a localized area by wireless transmitter 418. Each of the plurality of mobile devices 416 includes a computer 426 and a computer readable storage medium 428. Further, each of the plurality mobile devices 416 may include the features described above in reference to mobile device 200 (shown in FIG. 2).

Each of the plurality of mobile devices 416 is capable of receiving a Wi-Fi signal. Computer readable storage medium 428 includes computer readable instructions for receiving the converted audio data output from audio data conversion device 414. In one example, the computer readable instructions are an application for a mobile phone. In alternate embodiments, the computer readable instructions are an application for a tablet, a portable computer, an mp3 player, or any other mobile device capable of receiving a Wi-Fi signal.

Users can then listen to the audio corresponding to the program currently being played on television 412 via headphones associated with one of the mobile devices 416. Further, the users may adjust a volume of their mobile device to a desired volume. In an alternate example, the mobile devices may be heard through a speaker associated with the mobile device. In another alternate example, the audio output may be presented in readable format on a screen of the mobile device in either of a foreign language or an original language of the raw audio output.

Turning now to FIG. 5, audio delivery system 400 can be used in combination with one or more other audio delivery systems, such as audio delivery system 500. Audio delivery system 500 (including an audio source 512, an audio conversion device 514, and a plurality of mobile devices 516) is substantially identical to audio delivery system 400. Thus, for the sake of brevity, each feature of audio delivery system 500 will not be redundantly explained.

Audio conversion device 514 is configured to receive a raw audio output signal from a separate television, a television 512, parse the raw audio data from television 512 into a plurality of data packets for transmission to network location 424, receive converted audio packets from network location 424, and transmit converted audio packets to plurality of mobile devices 516. In an alternate embodiment, audio conversion device 514 may be an internal component of television 512. In an additional alternate embodiment, a single audio conversion device (audio conversion device 412) may receive raw audio output from multiple audio sources, such as television 412 and television 512. In this alternate embodiment audio conversion device 412 may include computer readable instructions for selectively transmitting either of converted audio packets from television 412 or television 512 depending on an audio source selection from a user.

Significantly, the plurality of mobile devices 416 and 516 may selectively receive converted audio packets from either of audio conversion device 414 or a separate audio conversion device, an audio conversion device 514. As depicted in FIG. 5, plurality of mobile devices 416 is receiving converted audio packets from audio conversion device 414 and plurality of mobile devices 516 is receiving converted audio packets from audio conversion device 514. Alternatively, any of the plurality of mobile devices 416 may receive converted audio packets from audio conversion device 514 and any of the plurality of mobile devices 516 may receive converted audio packets from the audio conversion device 414. Thus, a user may listen to and/or read audio output from either the program currently being played on television 412 or the program currently being played on television 512.

In one example, a first user may be listening to audio or reading text corresponding to the raw audio output of a first program from television 412 and a second user may be listening to audio or reading text corresponding to the raw audio output of a second program from television 512. In this example, the first and second users may be adjacent to each other (e.g., sitting at the same table or standing next to each other) and be able to hear high quality audio or read text undisturbed by the non-selected audio and/or the audio from of the adjacent user.

In a second example, a user may be listening to audio or reading text corresponding to the raw audio output of a first program from television 412 and then switch to listening to audio or reading text corresponding to the raw audio output of a second program from television 512. In this example, the user may easily listen to and/or read audio output from either of the first or second programs without disruption from the non-selected audio. Further, the user may selectively switch between listening to and/or reading audio output from the first and second programs by alternatively selecting audio output streaming from the first television and the second television.

Turning now to FIG. 6, an audio delivery system 600 is depicted. Audio delivery system 600 includes many similar or identical features to audio delivery systems 300, 400, and 500. Thus, for the sake of brevity, each feature of audio delivery system 600 will not be redundantly explained. Rather, key distinctions between audio delivery system 600 and audio delivery systems 300, 400, and 500 will be described in detail and the reader should reference the discussion above for features substantially similar between the audio delivery systems.

Audio delivery system 600 includes an audio source 612, an audio conversion device 614, and a plurality of mobile devices 616. Audio delivery system 600 can optionally include translator 632 (shown in dashed lines in FIG. 6). Audio conversion device 614 includes a wireless transmitter 618, a computer 620, and a computer readable storage medium 622. In other examples, the audio delivery system may include a separate wireless transmitter that is not an internal component of the audio output conversion device. Computer 620 may include the components described above in reference to computer 101 (shown in FIG. 1).

Computer readable storage medium 622 includes computer readable instructions for receiving the raw audio output in a first format, parsing the raw audio output into a plurality of data packets, converting the data packets from the first format to a second format, and transmitting the converted audio packets to the plurality of mobile devices. Additionally or alternatively, when a translator 632 is used for language translation, computer readable storage medium 622 further includes computer readable instructions for receiving language translation from the translator.

A flow of input and output data is depicted in FIG. 6. A raw audio output signal from audio source 612 is sent to audio conversion device 614. Audio source 614 may be any of the audio sources described above (e.g., a microphone, a television, a film, a theatrical presentation, etc.). The audio source may be set to any desired volume. Generally, raw audio output data is in one or more of the raw audio formats described above in reference to FIG. 3.

Rather than parsing the audio data for transfer to a network location for audio data for conversion, audio delivery system 600 parses audio data into a plurality of data packets and converts audio data from the first format to the second format within audio conversion device 614. Accordingly, raw audio data output is parsed by dividing the data into smaller portions or data packets. The raw audio data may be parsed in the manner described above in reference to FIG. 3. Further, data packets may be labeled with metadata tags as described above in reference to FIG. 3.

As audio conversion device 614 is configured to not only parse the data, but also to convert the first format to the second format. Thus, automatic language translation and/or automatic audio frequency enhancement are performed. In an example of audio frequency enhancement, one or more specific frequency ranges are enhanced (e.g., bass frequency, mid frequency, high frequency, etc.). The enhanced frequency range audio (selected enhanced frequency ranges) can then be combined with the normal frequency audio data (non-selected frequency ranges). In one example for language translation, language translation is an audible foreign language translation of the raw audio output. In another example, language translation is readable text foreign language translation. In even another example, language translation is a readable text original language translation.

Additionally or alternatively, the raw audio output signal can be sent to a translator 632. Translator 632 can be a human translator that is local or remote to audio source 612. In one example, the raw audio output can be sent to translator 632 via a hard wired internet connection through audio conversion device 614. In other examples, the translator is present in the conference room and directly hears the raw audio output, the audio is sent to the translator via a radio transmission, telephone transmission, or the audio is sent through a speaker system.

Translator 632 performs a language translation of the raw audio output, such as the translations described above. Translated audio output is then sent to audio conversion device 614. From audio conversion device 614, converted data packets are sent to mobile devices 616 through a wireless network (such as those described above in reference to FIG. 3) provided in a localized area by wireless transmitter 618.

Each of the plurality of mobile devices 616 is capable of receiving a Wi-Fi signal. Each of the plurality of mobile devices 616 includes computer 626 and a computer readable storage medium 628. Further, each of the plurality mobile devices 616 may include the features described above in reference to mobile device 200 (shown in FIG. 2).

Computer readable storage medium 628 includes computer readable instructions for receiving the audio data output from audio data conversion device 314. In one example, the computer readable instructions are an application for a mobile phone. In alternate embodiments, the computer readable instructions are an application for a tablet, a portable computer, an mp3 player, or any other mobile device capable of receiving a Wi-Fi signal. Users may then listen to the audio corresponding to the given presentation via headphones associated with one of the mobile devices 616. Further, the users may adjust a volume of their mobile device to a desired volume. In alternate examples, the mobile devices may be heard through a speaker associated with the mobile device and/or the user may view closed-captioning on a screen of their mobile device.

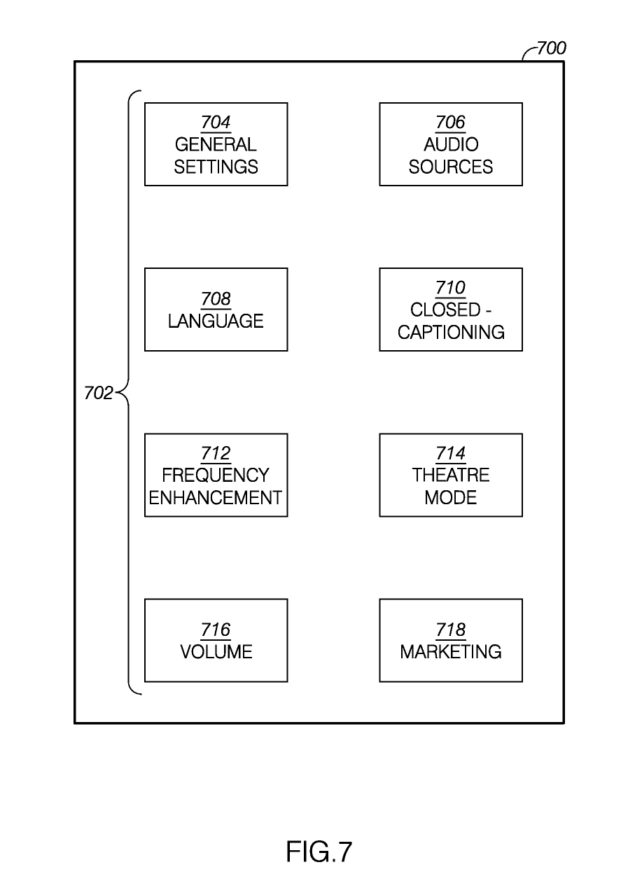

FIG. 7 shows a schematic view of an example graphical user interface (GUI) 700 for a mobile device 716 that is configured for user interaction with an audio delivery system (such as audio deliver systems 300, 400, 500, and 600). Mobile device 716 can be one of any of the plurality of mobile devices 316, 416, 516, and 616. The computer readable storage media (such as computer readable storage media 328, 428, and 628) for the mobile devices include computer readable instructions for displaying and responding to selection of one or more features of GUI 700. In one example, GUI 700 is displayed on a touch screen and responds to touch selection of one or more features. In other examples, GUI 700 may be displayed on a screen and selection of one or more features may be carried out through selection with a cursor of a mouse and/or buttons of the mobile device.

As depicted in FIG. 7, GUI 700 includes a plurality of selectable modules 702. In this example, plurality of selectable modules 700 includes a general settings module 704, an audio source module 706, a language module 708, a closed-captioning module 710, a frequency range enhancement module 712, a theater mode module 714, a volume module 716, and a marketing module 718. It will be appreciated that in alternate examples, the GUI may include additional selectable modules. It will also be appreciated than in other alternate examples, the GUI may include fewer selectable modules.

General settings module 704 includes selectable settings for the GUI, connection to the wireless network, and/or any other desired selectable settings for the audio delivery system. For example, a user may select an appearance of the GUI, such as a desired background, a desired text size, a desired coloration, etc. In another example, a user may select to connect and/or disconnect from the wireless network.

Audio source module 706 includes selectable settings for a desired source of audio output. For example, a user may select to receive audio from either of a first source or a second source, such as television 412 and television 512 of FIG. 5. In another example, a user may select a first audio source and the switch to a second audio source. It will be appreciated that an audio delivery system may include any number of audio sources and a user may select any one of the audio sources. Further, it will be appreciated that the user can switch to any one of the other audio sources at any time during use of the audio delivery system application.

Language module 708 includes selectable settings for a desired language translation. For example, a program and/or presentation may be presented in a first language and a user may select a second language. In this example, although the program and/or presentation is given in the first language, the user receives the audio output in the second language. The user may receive the audio output in either or both of an audible foreign language translation (i.e., spoken language) and/or a readable text foreign language translation (i.e., closed-captioning).

A user can select display of readable text via closed-captioning module 710. In one specific example, readable text may be selected that is a readable text original language translation (e.g., the presentation is given in English and the readable text is in English). In another specific example, the presentation is given in a first language (e.g., English) and the readable text is presented in a second language (e.g., Spanish). It will be appreciated that an audio delivery system may include any number of selectable languages and a user may select any one of the selectable languages. Further, it will be appreciated that the user can switch to any one of the selectable languages at any time during use of the audio delivery system application.

A user can select enhancement of one or more specific frequency ranges via frequency range enhancement module 712. For example, a user can select one or more of a high (e.g., 2048-8192 Hz), mid (e.g., 512-2048 Hz), or low (e.g., 32-512 Hz) frequency. Selection of a specific frequency range may allow a user with a partial hearing impairment to sufficiently hear audio output, even in a high ambient noise environment. It will be appreciated that frequency ranges may be divided into even further into more specific frequency ranges (e.g., 512-1050 Hz and 1051-2048 Hz, etc.).

Theater mode module 714 includes specific pre-set settings for use of the mobile device in a theater environment. For example, a brightness of the screen can be automatically dimmed. In another example, a volume for a ringer of the phone can be automatically muted. It will be appreciated that the theater mode module may include other features that are desirable in a theater environment.

Volume module 716 includes selectable settings for a desired volume of audio output received by the user. Accordingly, a user may select and/or change a desired volume during use of the audio delivery system application. Further, a user can select a mute option. The muted option may be desirable for use with closed-captioning. Additionally or alternatively, a user may select a desired volume using another volume control, such as a main volume of the mobile device or a volume control on a pair of headphones.

Marketing module 718 is configured to provide viewable and/or selectable advertising materials. Using marketing module 718, an operator of the audio delivery system (e.g., host of a conference, restaurant owner, theater owner, etc.) can deliver marketing content to a user during use of the audio delivery system application. For example, an advertisement may be displayed on the screen (or a portion of the screen) of the mobile device while a user is receiving the audio output. In one specific example, marketing module 718 can deliver a coupon or an offer to a user that a user may select for download. In another specific example, marketing module 718 can deliver an advertisement that is a viewable advertisement. In even another specific example, marketing module 718 can deliver an advertisement that includes a selectable hyperlink to a webpage. It will be appreciated that the marketing module may target specific marketing material to users depending on a location of the user, a program currently being watched by the user, and/or other demographic information of the user.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. An audio delivery system, comprising:
an audio source, the audio source configured to deliver raw audio output in a first format;
an audio conversion device having a first computer and a first computer readable storage medium, the audio conversion device configured to:
receive the raw audio output,
parse the raw audio output into a plurality of data packets,
transmit the plurality of data packets to a network location for converting the plurality of data packets into converted data packets in a second format,
receive the converted data packets from the network location, and
transmit the converted data packets over a wireless network;
a wireless transmitter configured to generate the wireless network in a localized area; and
a plurality of mobile devices, each of the plurality of mobile devices having a second computer, a second computer readable storage medium, and a screen, each of the plurality of mobile devices configured to:
receive instructions from a user of a mobile device,
receive the converted data packets, and
present the converted data packets in the second format to the user based on a selection by the user.

2. The audio delivery system of claim 1, wherein the first format is a first language format and the second format is a second language format, the second language format being an audible foreign language translation of the first language format, the audible foreign language translation projected through at least one speaker associated with one of the plurality of mobile devices for delivery to the user.

3. The audio delivery system of claim 1, wherein the first format is a first language format and the second format is a second language format, the second language format being a readable text foreign language translation of the first language format, the readable text foreign language translation displayed on the screen of one of the plurality of mobile devices for presentation to the user.

4. The audio delivery system of claim 1, wherein the first format is a first language format and the second format is a second language format, wherein the second language format is a readable text original language translation of the first language format, the readable text original language translation displayed on the screen of one of the plurality of mobile devices for presentation to the user.

5. The audio delivery system of claim 1, wherein the first format is a normal frequency level format and the second format is an enhanced frequency level format, the enhanced frequency level format having increased audio projection of one or more specific audio frequency ranges selected by the user, the enhanced frequency audio projected through at least one speaker associated with one of the plurality of mobile devices for delivery to the user.

6. The audio delivery system of claim 1, wherein the audio conversion device is further configured to temporally parse the raw audio output into a plurality of data packets based on a duration of time of the raw audio output.

7. The audio delivery system of claim 1, wherein the audio conversion device is further configured to parse the raw audio output into a plurality of data packets based on a frequency range of the raw audio output.

8. The audio delivery system of claim 1, wherein the audio conversion device is further configured to add at least one metadata tag to each of the plurality of data packets, the at least one metadata tag comprising a header, the header designating one of an audio data and a text data, the audio data having priority over the text data during transmission of the plurality of data packets through the audio delivery system.

9. The audio delivery system of claim 1, wherein the first computer readable storage medium comprises computer readable instructions for receiving the raw audio output in the first format, parsing the raw audio output into the plurality of data packets, transmitting the plurality of data packets to the network location for converting the plurality of data packets into converted data packets in the second format, receiving the converted data packets from the network location, and transmitting the converted data packets over the wireless network.

10. The audio delivery system of claim 1, further comprising an audio delivery system graphical user interface for display on at least a first portion of the screen and for receiving instructions from the user through one of the plurality of mobile devices, the audio delivery system graphical user interface having a plurality of selectable modules, the plurality of selectable modules being one or more of a language module, a closed-captioning module, an enhanced audio frequency module, an audio source module, a general settings module, a volume module, a theater mode module, and a marketing module.

11. The audio delivery system of claim 10, wherein the second computer readable storage medium includes computer readable instructions for displaying the graphical user interface, receiving instructions from the user, receiving the converted data packets, and reproducing/presenting the converted data packets in the second format to the user.

12. The audio delivery system of claim 10, wherein the language module comprises at least one selectable foreign language, the at least one selectable foreign language selected by the user to receive a foreign language translation of the raw audio output.

13. The audio delivery system of claim 10, wherein the closed-captioning module comprises a selectable readable text, the selectable readable text selected by the user to receive a readable text translation of the raw audio output.

14. The audio delivery system of claim 10, wherein the enhanced audio frequency module comprises one or more selectable audio frequency ranges, the one or more selectable audio frequency ranges selected by the user to receive an enhanced audio signal where the one or more selectable audio frequency ranges are amplified over other audio frequency ranges.

15. The audio delivery system of claim 1, wherein the wireless transmitter is an internal component of the audio conversion device.

16. An audio delivery system, comprising:
an audio source, the audio source configured to deliver raw audio output in a first format;
an audio conversion device having a first computer and a first computer readable storage medium, the audio conversion device configured to
receive the raw audio output,
parse the raw audio output into a plurality of data packets, the plurality of data packets being converted into converted data packets in a second format, the second format being at least one of an audible foreign language translation, a readable text foreign language translation, a readable text original language translation, and an audible enhanced frequency range audio output, and
transmit the plurality of data packets over a wireless network;
a wireless transmitter configured to generate the wireless network in a localized area; and
a plurality of mobile devices, each of the plurality of mobile devices having a second computer, a second computer readable storage medium, a screen, and at least one speaker associated with the mobile device, each of the plurality of mobile devices configured to
display a graphical user interface,
receive instructions from a user,
receive the converted data packets, and
present the converted data packets to a user in the second format, the audible foreign language translation and the enhanced frequency range audio output projected through the at least one speaker for presentation to the user, the readable foreign language translation and the readable original language translation displayed on the screen for presentation to the user.

17. The audio delivery system of claim 16, further comprising a human translator, the human translator configured to receive the raw audio output, translate the raw audio output from the first language format into the second language format, and transmit translated audio output to the audio conversion device.

18. The audio delivery system of claim 16, wherein the audio conversion device is further configured to transmit the plurality of data packets to a network location for converting the plurality of data packets in the first language format into the converted data packets in the second language format and to receive the converted data packets from the network location.

19. The audio delivery system of claim 16, wherein the graphical user interface is displayed on at least a portion of the screen, the graphical user interface comprising a plurality of selectable modules, the plurality of selectable modules including at least a language module, a closed captioning module, and a frequency range enhancement module, the language module having at least one selectable foreign language, the at least one selectable foreign language selected by the user to receive one more of the audible foreign language translation and the readable foreign language translation, the closed-captioning module having a selectable readable text, the selectable readable text selected by the user to receive one or more of the readable text foreign language translation and the readable text original language translation, the frequency range enhancement module having at least one selectable frequency range, the at least one selectable frequency range selected by a user to receive increased audio projection of one or more specific audio frequency ranges.

20. An audio conversion device, the audio conversion device configured to receive raw audio output in a first format from an audio source, parse the raw audio output into a plurality of data packets, convert the plurality of data packets into converted data packets in a second format, and transmit the converted data packets over a wireless network to a plurality of mobile devices, the audio conversion device comprising:
a computer, the computer having a processing unit;
a wireless transmitter, the wireless transmitter configured to generate the wireless network in a localized area; and
a computer readable storage medium, the computer readable storage medium having computer readable instructions for the processing unit, the computer readable instructions being instructions for
receiving the raw audio output in the first format from the audio source,
parsing the raw audio output into a plurality of data packets,
converting the plurality of data packets into converted data packets in the second format, the second format being one or more of an audible foreign language translation, a readable text foreign language translation, a readable text original language translation, and an audible enhanced frequency range audio output, and
transmitting the converted data packets over the wireless network to the plurality of mobile devices.
